(19) United States
(12) Patent Application Publication
(10) Pub. No.: US 2003/0025108 A1
(43) Pub. Date: Feb. 6, 2003

(54) Apparatus to stretch bands

(76) Inventor: Giuseppe Seroldi, Seregno (IT)

Correspondence Address: NOTARO & MICHALOS P.C., Empire State Building, Suite 6902, 350 Fifth Avenue, New York, NY, 10118-6985, US

(21) Appl. No.: 10/046,350

(22) Filed: Jan. 14, 2002

(30) Foreign Application Priority Data
Apr. 5, 2001 (IT) MI2001U 000202

(51) Int. Cl. B66F 3/00

(52) U.S. Cl. 254/219

(57) ABSTRACT

This invention relates to an apparatus to stretch elastic and non-elastic bands to be applied to furniture frames, characterized in that it provides for:

one or more belt-feeding bobbins;

a roller rotating on its own axis;

a bar applied to said roller at such a distance as to enable the inserting, between the bar and the roller, of the belts being then bent backwards in order to be fixed to the furniture frame;

an arm controlling the rotation of said roller;

a piston activating said arm;

devices fit to regulate the pressure of the fluid activating said piston.

With respect to the known solutions, in which the amplitude of the rotation of the roller was determined by means of a mechanical stopping device and regardless of the force applied to it, in the apparatus according to the invention the pressure of the fluid controlling the rotation of the roller is regulated in such a way as to enable an automatic adjustment of the stretching according to the pressure set and then to the tensile strength of the different types of elastic belt to be stretched

This invention relates to an apparatus to stretch bands or belts, in particular elastic bands to be applied to furniture frames, in which devices are provided for, fit to regulate the rotation of the roller stretching the belts, so as to apply a predetermined adjustable force to them.

With respect to the known solutions, in which the amplitude of the rotation of the roller was determined by a mechanical stopping device and regardless of the force applied to it, in the apparatus according to the invention the pressure of the fluid controlling the rotation of the roller is regulated in such a way as to enable an automatic adjustment of the stretching according to the pressure set and then to the tensile strength of the different types of elastic belt to be stretched.

More in detail the apparatus according to the invention includes a roller rotating on its own axis, on which a bar is fitted kept at a certain distance from the roller so as to enable the inserting, between the bar and the roller, of the bands, which are then bent backwards over said bar in order to be fixed to the furniture frame.

During the first phase of the rotation of the roller, said bar exerts a slight tractive force on the bands by friction but still letting them slide along the roller, the following rotation of the roller making the bent-backwards part of the band lean against the part of the band coming from the bobbin, level with at least a part of the surface of the roller, the sliding of the band being thus prevented because of friction, the following rotation of the roller causing the stretching of said bands.

A pneumatic-piston-controlled arm is integral with said roller and devices are provided for, fit to regulate the pressure of the fluid activating said pneumatic piston, so as to vary at will the moment to be exerted on the roller and consequently the tractive force it exerts on the bands.

This way it is possible to adjust the tractive force according to the tensile strength of the elastic belts, thus obtaining the wanted degree of stretching.

To build supporting tops for sitting-plates of pieces of furniture such as sofas, armchairs, chairs or the like, a number of elastic bands or belts are often applied to a perimetric frame, by being fixed to one side of the frame, stretched and then fixed to the opposite side.

They are belts of elastic material of different size and different tensile strength, which are to be stretched in a uniform way.

To this purpose apparatuses for the straining and stretching of more parallel belts or bands are known and in particular, from the Italian utility model n. 221.846 of the same applicant, an apparatus is known to stretch bands including a number of bobbins feeding the bands, a stretching roller rotating on its own axis, to which a bar is applied kept at such a distance from the surface of the roller as to enable the inserting between the bar and the roller of the belts which are then bent backwards and fixed to one side of the frame. An arm controlled by a pneumatic piston is integral with the roller, said piston making the roller rotate with the bar to stretch the belts which are then fixed also to the opposite side of the frame.

In this apparatus a number of stroke-end mechanical components are provided for, fit to control the arm activating the rotation of the roller, in order to reduce its stroke and thus regulate the degree of stretching of the belts.

This apparatus offered excellent results as, thanks to the layout of the different parts, at the beginning of the rotation of the roller the belts can slide along the bar, so as to be slightly stretched in a uniform way, while by the following rotation of the roller the belts are kept steadily fastened to the roller itself by friction and are stretched in a uniform way being the stretch proportional to the amplitude of the rotation.

This apparatus is still further perfectible, in particular with regard to the system regulating the tractive force on the belts.

In fact, the known apparatus does not sense the difference among the elastic belts being used and the stroke of the roller is automatically regulated, regardless of the tensile strength exerted by the belts.

The applicant has now set an improved apparatus, object of this invention, in which the stroke of the roller is controlled by properly regulating the pressure of the fluid sent to the piston controlling the rotation of the roller.

This way it is possible to regulate the stroke of the roller according to the tensile strength of the elastic belts being used.

This invention will be hereby described in detail, by way of a not limitative example, with reference to the figures enclosed, in which:

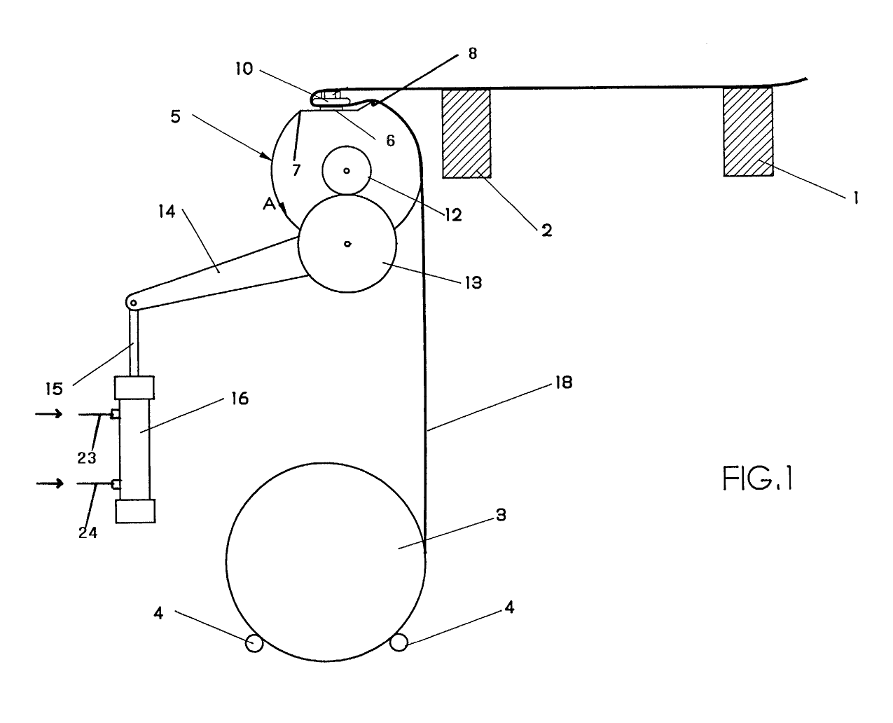

FIG. 1 is a schematic view of the stretching device in an apparatus according to the invention, in the position at the beginning of the stretching cycle,

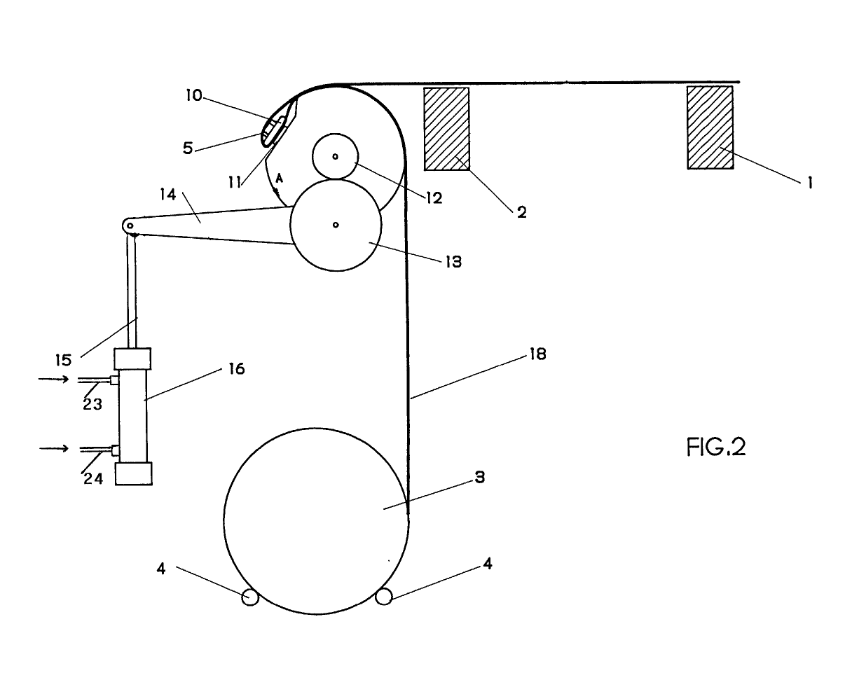

FIG. 2 is a view similar to that of FIG. 1, being the apparatus in the position it is in during the stretching cycle;

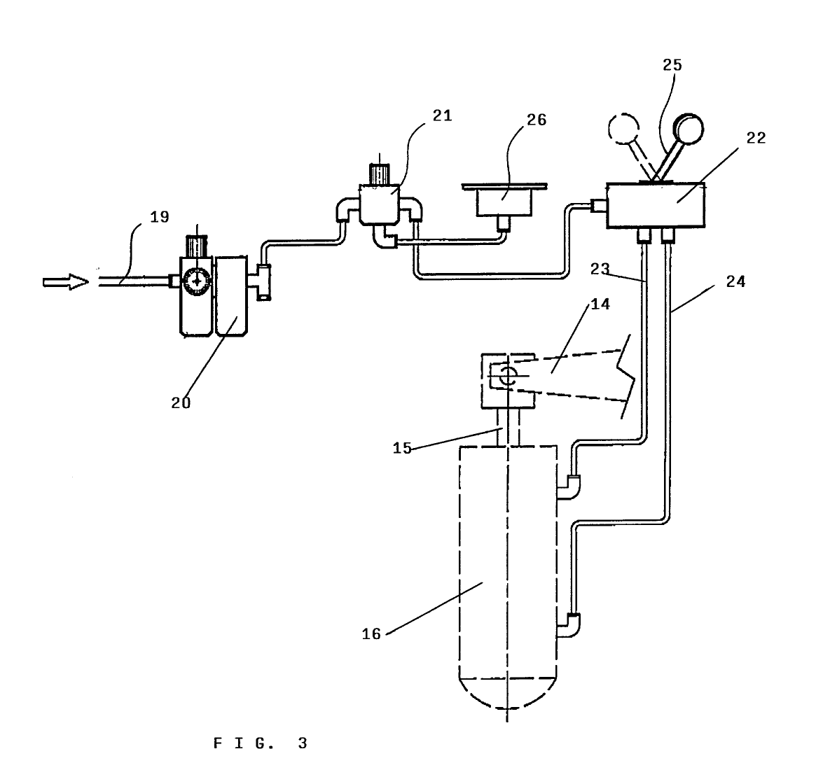

FIG. 3 is a diagram showing pneumatic devices regulating the amplitude of the rotation of the roller in the apparatus according to the invention.

With reference to FIG. 1, number 1 and 2 show the two opposite sides of the frame of a piece of furniture the elastic belts are to be applied to.

Said belts, shown under number 18, are fed by a number of bobbins 3 laid side by side and put on supports such as rollers or the like 4 enabling them to unwind.

To facilitate the reading, the drawings do not show the frame of the apparatus, but only its main parts necessary to understand its running.

The stretching device includes a stretching roller 5 in which a cavity is made having a flat bottom wall 6, which, on one side, forms a corner 7 with the surface of the roller and, on the other side, turns upwards being linked up to the surface of the roller at a round corner shown under number 8.

To the bottom wall 6 a number of spacers are fixed on which a bar 10 is installed being fixed by means of screws or the like.

Roller 5 is made to rotate by means of an arm 14 activated by a rod 15 of a pneumatic piston 16.

Arm 14 can be fixed directly to one of the roller ends or, as shown in the figure, it can control the roller by means of a multiplying device including a cog-wheel 12 coaxial with the roller, which is connected to a second cog-wheel 13 to which arm 14 is fixed.

According to the invention, a pneumatic circuit, shown in FIG. 3, is provided for to activate piston 16.

Number 19 shows a feeding line of a fluid, in particular under-pressure air, coming from a distribution network or from a compressor not shown in the figure, which passes to a filter 20, goes to a pressure regulator 21 of known type and then to a distribution valve 22 connected, by means of ducts 23 and 24, to the two double-acting piston chambers 16. Valve 22 is activated by an operator by means of a lever 25.

Number 26 shows a gauge or the like enabling to visualize the pressure set by means of regulator 21. This regulator can be of any of the known types, such as LRP ¼ type made by the firm Festo.

Regulator 21 enables to regulate the value of the pressure of the fluid being sent to piston 16.

The running is carried out in the following way.

Belts 18 are uncoiled manually and partially wound around roller 5 by the area fronting onto the furniture frame. They are inserted between roller and bar 10 being brought around round corner 8, after that they are bent backwards passing over bar 10 so as to take the end of the belts into contact with edge 1 of the frame, to which the belts are fixed in a known way, such as by means of fasteners, nails or the like.

In this position if disk 5 is rotated in the direction of the arrow F, the side edge of bar 10 will exert, by friction, a certain tractive force on the belts, which can still slide between the roller and the bar.

This way during the first phase of rotation of roller 5 the belts, being fixed to side 1 of the frame, are stretched and slightly tensioned, basically with the same force.

As the rotation of roller 5 goes on, this comes to the position as shown in FIG. 2, in which the part of the belt that goes to the frame is put on the part of the belt wound around the roller and the very tension of the belt pushes the two overlapping parts of the belt one against the other, thus fastening them because of the friction: consequently the second phase of rotation of roller 5 causes the stretching of the belts with a force being proportional to the amplitude of the rotation.

The regulation of the stroke and then of the degree of stretching of the belts is carried out by properly operating the pneumatic circuit and in particular pressure regulator 21.

By operating it, the value of the pressure of the air to be sent to piston 16 is programmed, being this value visualized on gauge 26.

The under-pressure air, coming from duct 29, is filtered through filter 20, then through control valve 22 and through ducts 23 and 24 it is driven to one or to the other chamber of double-acting piston 16.

By this system the amplitude of the rotation of roller 5 won't be regulated mechanically any more but it will be proportional to the pressure of the air sent to the piston.

Practically the rotation of the roller will continue as far as the force exerted by piston 16 is balanced by the tensile strength of the elastic belts.

This way it is possible to regulate the stretching of the belts with great accuracy by simply varying the pressure of the air to be sent to the piston and consequently the force it exerts on arm 14.

This layout enables, as it clearly results from the supplied description, to regulate very easily the degree of stretching of the belts, simply by properly regulating, to this purpose, the pressure of the air. The stroke of the roller will then finish when the belts are stretched at the right degree.

In substance, the tractive force applied to the belts does not depend on their size and it is then easier and more simply to regulate.

Obviously size and materials to be used can change according to use requirements.

1) An apparatus to stretch elastic and non-elastic bands to be applied to furniture frames of a type comprising a number of bobbins for band-feeding, a roller rotating on its own axis, on which a bar is fitted being kept at such a distance as to enable the inserting of the bands, said bands being bent backwards and over said bar in order to be fixed to the frame, so that, due to the rotation of the roller, the bent-backwards part of the band is laid on the part of the band which is coming from the bobbin on at least a part of the surface of said roller, being the sliding of the band then prevented by friction so that the following rotation of the roller causes the stretching of said bands, characterized in that it provides for devices fit to apply to the roller a moment of a predetermined at-will-adjustable value.

2) An apparatus to stretch bands according to claim 1 characterized in that it provides for devices fit to regulate the amplitude of rotation of said roller according to the tractive force to be applied to the belts.

3) An apparatus to stretch belts according to claim 1, in which a piston is provided for activating an arm connected directly or by a revolution-multiplying device to said roller, characterized in that it provides for devices fit to regulate the pressure of the fluid activating said piston.

4) An apparatus to stretch belts according to claim 3, characterized in that it provides for a pressure regulator put on the feeding circuit of the fluid activating said piston.

5) An apparatus to stretch elastic and non-elastic bands to be applied to furniture frames, characterized in that it provides for:
one or more belt-feeding bobbins;
a roller rotating on its own axis;
a bar applied to said roller at such a distance as to enable the inserting, between the bar and the roller, of the belts being then bent backwards in order to be fixed to the furniture frame;
an arm controlling the rotation of said roller;
a piston activating said arm;
devices fit to regulate the pressure of the fluid activating said piston;

6) An apparatus to stretch elastic and non-elastic bands to be applied to furniture frames as described and shown.
